(19) United States
(12) Patent Application Publication
(10) Pub. No.: US 2017/0066454 A1
(43) Pub. Date: Mar. 9, 2017

(54) Global Constant Temperature and Pulley Conduit Transportation Network with Intelligent Control System

(71) Applicants: Zhenkun Wang, Ashburn, VA (US); Xiyou Wang, Ashburn, VA (US)

(72) Inventors: Zhenkun Wang, Ashburn, VA (US); Xiyou Wang, Ashburn, VA (US)

(21) Appl. No.: 15/048,606

(22) Filed: Feb. 19, 2016

(30) Foreign Application Priority Data
Sep. 7, 2015 (CN) 201520685704.7
Dec. 2, 2015 (CN) 201520685691.3

(51) Int. Cl. B61B 13/10; G05D 1/00; B61L 27/04

(52) U.S. Cl. CPC B61B 13/10; B61L 27/04; G05D 1/0005

(57) ABSTRACT

A global constant temperature and pulley conduit transportation network with intelligent control system includes some air inlets, some temperature detectors, some fans, some pressure detectors, some covers for air inlets, some filters, some personal door conduits, some sub-conduits, a main conduit, some seat-associated control computers, and some recumbent seats attached to bottom rollers, so that the personal door conduit connects to a plurality of residential buildings via the main conduit, and the recumbent seat is transported from a residential building entrance through the personal door conduit and main conduit to a destination under the automatic control of the seat-associated control computer. This permits a comfortable and individualized seat to be connected to a number of vehicles, to enable travel with children or with goods starting from their own doorstep and ending at the designation without leaving the seat through computer controlled route selection and speed control to minimize the need for braking, avoid the traffic congestion problems, and save energy and time.

### CROSS-REFERENCE TO RELATED APPLICATIONS

This application claims priority to Chinese Patent Application No. 201520685704.7 filed in the Chinese Patent Office on Sep. 7, 2015 and No. 201520685691.3 filed in the Chinese Patent Office on Dec. 2, 2015, the entire contents of which are incorporated herein by reference.

### BACKGROUND OF THE INVENTION

In science and technology today, transportation systems are gradually improving, and new modes of transportation are emerging. However, modern transportation systems still require the attention and decision making of human drivers and operators, which leads to inefficiencies both in fuel usage and in human labor time. Even though people nowadays have invented “self-driving” vehicle in Germany, it still needs a person to sit behind the wheel to monitor. The computer can never react to any new incident that has not been stored in its system. Also people cannot input every possible situation to the computer in advance. Therefore, it is impossible to invent a true “self -driving” vehicle. Most of the energy waste on traffic jam and brake. More important, traffic accidents and airplane crashes cause innumerable number of death every year. Human has paid disastrous price on transporting resources and us. Thus, there exists a need for transportation systems that lessen these societal burdens and eliminate human catastrophes. In addition, as the use of air condition and heater has become more widespread, people have used enormous amount of energy on these. With the continuing advancement of electronic technology, the application of intelligent transportation systems is such as information technology, computer technology, data communication technology, sensor technology, electronic control technology, automatic control theory, operations research, artificial intelligence and other advanced technologies to the integrated transport, service control and vehicle manufacturing, has much promise to improve the usability, efficiency and safety of vehicles and roads. There still exists a need for intelligent transportation systems, which would alleviate traffic congestion and air pollution in the world, while greatly improving transport efficiency. Since the intelligent control system locates inside of a conduit, needs for oxygen, suitable temperature and proper air pressure are emerged. These needs could be solved by transferring air from south polar, north polar, and equator through air inlets that install among these three locations where have the proper temperature. Therefore, the conduits in this invention have two purposes: constant temperature system and intelligent control transportation system.

### BRIEF SUMMARY OF THE INVENTION

This invention is directed to a solution to the above problems that provides global constant temperature and pulley conduit transportation network with an intelligent control system.

The system composes with multiple personal door conduits that are connected directly to each family, several sub-conduits that connect with towns and cites, and these personal door conduits and sub-conduits are collected to a main conduit. The conduits that are connected directly to each family and the main conduit can go below the ground, above the ground, and under the water. These conduits serve two functions: providing constant temperature to each family and transportations.

### BRIEF DESCRIPTION OF THE SEVERAL VIEWS OF THE DRAWINGS

FIG. 1 is a diagram of the structure of an air inlet and the main conduit of constant temperature pulley conduit transportation network with an intelligent control system.

FIG. 2 is a diagram of the constant temperature pulley conduit transportation network with an intelligent control system in detail of sub-conduit to each building.

FIG. 3 is a perspective view of two recumbent seats, each with a seat-associated control computer, linked together.

### DETAILED DESCRIPTION OF THE INVENTION

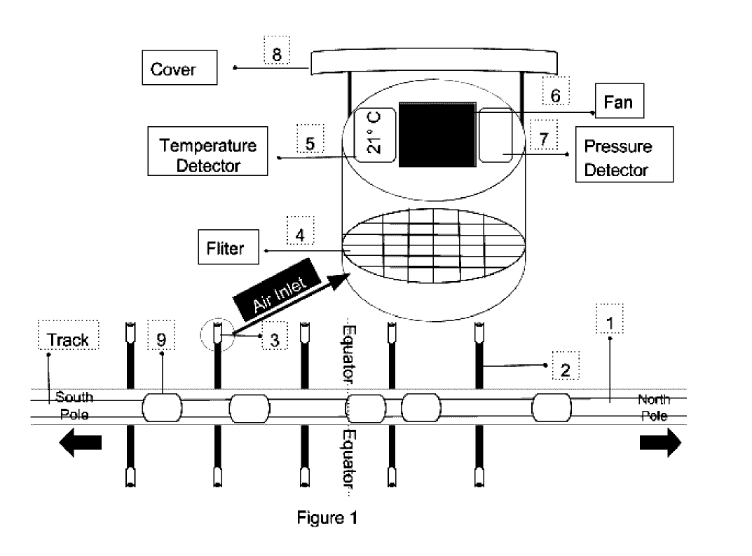

As seen in the FIG. 1, the cover 8 protects rain gets into the conduit. As temperature detector 5 detects the proper temperature (21° C.), fan 6 starts to inhaling air in. Then a filter 4 filtrates the air from outside before the 21° C. air goes into the main conduit 1. When the pressure detector 7 detects the pressure is too high, fan 6 stops working.

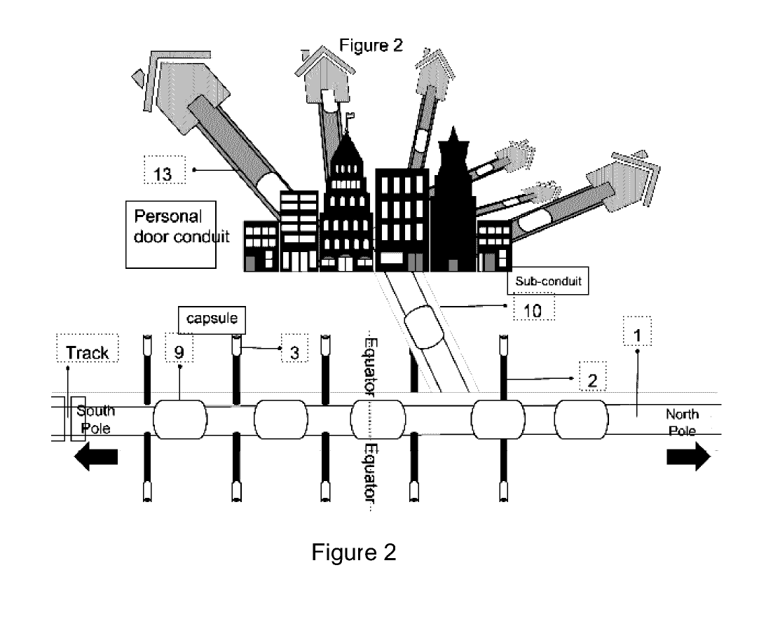

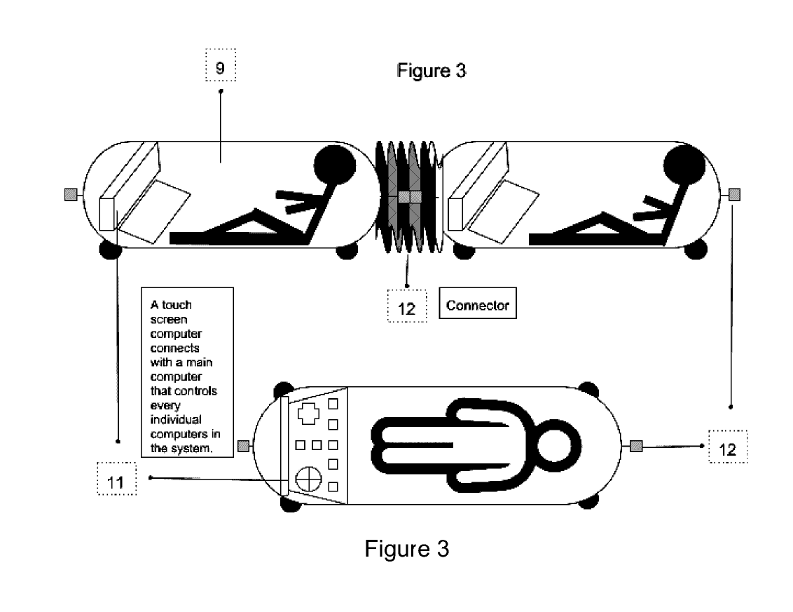

As seen in FIG. 2, the pulley conduit transportation network with an intelligent control system comprises personal door conduit 10 connecting residential building entrance to a main conduit 1. Thus, the network provides door-to-door connectivity. Traversal of the network occurs by use of a rolling recumbent seat 9 with a seat-associated computer 12, as shown in FIG. 3. An individual seat-associated control computer 12, and integrated recumbent seat 9, is boarded at the entrance doorways of a residential building to then enter the transportation network though personal door conduit 10 and automatically travel to a destination via the main conduit 1. In this way, goods or personnel can be automatically transported in the recumbent seat 9 atop bottom rollers through the network from an entrance doorway of a residential building to any network destination set in the seat-associated control computer 11.

In the above structure, the seat-associated control computer 11 automatically sets parameters to determine the speed, route selection parameters and other information, so that goods or persons in a recumbent seat 9 can depart from personal door conduit 10, and arrive at a destination under computer-automated control.

In order to further improve transportation efficiency, many residential building entrances are connected via personal door conduits 10 to the main conduit 1, respectively. A number of personal door conduits 10 connect to the main conduit 1, and the integrated seat-associated control computer 11 and recumbent seat 9 travels through the personal door conduits 10 and the main conduit 1 on bottom rollers.

As seen in the FIG. 3, a passenger uses the integrated seat-associated control computer 11 to enter the destination that one needs to go and a connector 12 connects two capsules 9 if needed.

The invention has the following technical solution to achieve the above purpose:

PART A:

The global constant temperature system, including some air inlets, some temperature detectors, some fans, some pressure detectors, some covers for air inlets, some filters, several personal door conduits, a main conduit. The network comprises a set of conduits connecting the entrance doorways of residential buildings and export conduits connecting the individual entrance doorways to a main conduit.

The locations of air inlets of global constant temperature system are selected base on the temperature of these locations. These locations should have air temperature at 21° C. (presume that 23° C. is the most the comfortable temperature to everyone, and 2° C. is the wastage) at least some time throughout the year. When the temperature detector inside of the air inlet detects the outside temperature is at 21° C. , the fan starts to inhale the outside air to the conduit. The openness of each air inlet controls by a small computer that attached with the air inlet. Then, the air at 21° C. fulfills all personal door conduits and a main conduit. Since the network comprises a set of conduits connecting the entrance doorways of residential buildings to the main conduit, the air at 21° C. in the personal door conduit can go to each buildings.

In order to provide a healthy air quality, the locations of air inlets should avoid industrial districts and cities.

Each air inlet has a pressure detector to ensure a suitable and safe environment inside of the conduit. The speed of the fan is base on the pressure inside of the conduit. As the pressure increases, the speed of the fan decreases.

An individual computer controls the operation of each air inlet. When an area occurs a disease that can be spread through air, the individual computer automatically closes the air inlet in that area to ensure the quality and safety of the air.

Overall, the global constant temperature conduit system that directly sends the constant air temperature through conduits to all families all year round can reduce the energy usage grammatically on air condition and heater, because a compressor is no longer needed to generate constant temperature; instead, a fan can make it possible. Thus, this system only needs a little energy. In addition, this system provides fresh, clean, and high quality of air to human generation.

PART B:

A pulley conduit transportation network with an intelligent control system, including a personal door conduit, a main conduit, a seat-associated control computer, and a recumbent seat is disclosed. The network comprises a set of conduits connecting the entrance doorways of residential buildings and export conduits connecting the individual entrance doorways to a main conduit. The network contains the recumbent seats with a seat-associated control computer situated in front of each recumbent seat, and bottom rollers below the recumbent seat.

Transportation in the above structure involves automated control by a seat-associated control computer of the speed and destination parameters and other information, so that goods or personnel can be automatically transported in the recumbent seat through the network from their entrance doorway to any network destination set in the seat-associated control computer.

Each person seated in a capsule shaped “car” and multiple capsules can connect together for family trip and personal uses. When one seat in, one only needs to enter the destination that one wants to go. Then, the seat-associated control computer calculates a most convenient route and speed so the capsule can move at a constant speed without getting into traffic. In this way, no wasted energy is created.

In order to reduce energy usage, the sub and main conduits should not have any steep inclination; however, if necessary these conduits should slope gently. Sharp turn and steep hill should be avoided.

For conduits below sea level, they should not have conflict with the waterline of ship. Also a rest area should be built on the surface of the water that directly above the conduit.

The capsule can also transport goods. People just need to enter the destination and the goods can arrive at the destination fast and safe.

In order to solve the problem of carsickness, the design inside of conduits is black so one would not see anything through the window of a capsule.

In order to further improve transportation efficiency, many residential building entrances are connected via personal door conduits to the main conduit, respectively.

In order to further improve the transportation efficiency, the seat-associated control computer and the recumbent seat have an integrated structure that travels through the conduits on bottom rollers.

When all of the families all over the world join into this system, this system can substitute car, plane, and ship.

This pulley conduit transportation network with an intelligent control system solves the trouble of transportation. It provides a quick, convenient, safe, steady, quite, and point-to-point transportation. Most important, it saves enormous time and energy because no traffic jams are created and no brakes are needed.

This above network design has the following benefits: 1. The recumbent seat is comfortable and efficient. 2. The recumbent seat can be connected chain of such vehicles, so that it is possible to travel with children or travel with goods, etc. 3. Each recumbent chair originates from, and is stored at, an individual residence. 4. The system enables a point-to-point transportation mode without the need to transfer seats, the computer automatically controls transport to the destination, intelligently manages traffic information and adjusts speed so as to obviate the need for braking. 5. The computer control enables selection of the best line and speed. 6. The system avoids traffic congestion problems. 7. The system saves energy and time. 8. The system improves transportation efficiency. 9. The system shares a healthy air quality globally. 10. The system provides a constant temperature all over the world. 11. The system solves the problem of carsickness.

The description above is intended to disclose the basic principles of the invention, including its the main features and advantages. Those of ordinary skill in the art should understand that the invention is not limited to the embodiments described above, and that the embodiments described above are merely illustrative of the principles of the invention. The scope of the invention is described in the clams and includes equivalents within the spirit and scope of the invention.

1. A global constant temperature and pulley conduit transportation network with intelligent control system, comprising:
a plurality of air inlets;
a plurality of temperature detectors;
a plurality of fans;
a plurality of pressure detectors;
a plurality of covers for air inlets;
a plurality of filters;
a plurality of personal door conduits;
a plurality of sub-conduits;
a main conduit;
a plurality of seat-associated control computers; and
a plurality of recumbent seats attached to bottom rollers;
wherein the personal door conduits connects to a plurality of residential buildings via the main conduit, and the recumbent seats are transported from a residential building entrance through the personal door conduit and main conduit to a destination under control of the seat-associated control computers.

2. The global constant temperature and pulley conduit transportation network with intelligent control system according to claim 1, wherein pluralities of residential building entrances are connected to the main conduit via multiple personal door conduits, respectively.

3. The global constant temperature and pulley conduit transportation network with intelligent control system according to claim 1, wherein the seat-associated control computer and the recumbent seat have an integrated structure that travels through the conduits on bottom rollers.
